(19) United States
(12) Patent Application Publication
(10) Pub. No.: US 2023/0071324 A1
(43) Pub. Date: Mar. 9, 2023

(54) RELAY DEVICE FOR WATERING SYSTEM WITH SOIL MOISTURE SENSOR

(71) Applicant: AEON MATRIX INC., Taipei City (TW)

(72) Inventor: MING-JE TSAI, Taipei City (TW)

(21) Appl. No.: 17/467,294

(22) Filed: Sep. 6, 2021

(51) Int. Cl. A01G 25/16; G05B 15/02

(52) U.S. Cl. CPC A01G 25/167; G05B 15/02

(57) ABSTRACT

A relay device capable of being connected between a main controller and an electronic valve and signally connected with a soil moisture sensor is provided. The relay device includes a first terminal, a second terminal, a transceiver, and a switch. The first terminal is for being electrically connected with the main controller. The second terminal is for being electrically connected with the electronic valve. The transceiver is for signally connected with the soil moisture sensor. The switch is for controlling an opening and closing of the electrical connection between the first terminal and the second terminal according to a soil moisture level received from the soil moisture sensor.

### BACKGROUND OF THE INVENTION

### 1. Field of the Invention

The present disclosure relates to a relay device for a watering system and, in particular, to a relay device for controlling one of the electronic valves in a watering system based on the condition of the soil moisture without affecting other electronic valves.

### 2. Description of the Related Art

Conventional watering systems are used to spray water over fields or lawns in order to provide moisture to grass or plants. In the past the conventional watering systems typically were manually controlled. This means that a physical human being was required to turn the sprinklers on or off by manually turning waterline valves open or closed and thereby turning the sprinkler water on or off.

More recently, for water-saving purposes, controls allowed watering system personnel to establish a watering schedule for the sprinklers while considering the soil conditions. For example, referring to FIG. 1, a conventional main controller 11 of a watering system 1 may have a plurality of valve-controlling ports VP1-VP4 and a sensor port SP. The valve-controlling ports VP1-VP4 are for controlling multiple electronic valves V1-V4, respectively, to control the water flow from a water source W to sprinklers. In FIG. 1, the electronic valve V4 controls the water flow from the water source W to a sprinkler 12. The sensor port SP is for receiving the soil moisture level sent from a soil moisture sensor 13. The main controller 11 controls the on and off of the electronic valves V1-V4 based on a pre-set watering schedule. The main controller 11 also controls all electronic valves V1-V4 based on the soil moisture level received at the sensor port SP. Once the soil moisture level indicates that the soil is too wet, the main controller 11 would turn off all electronic valves V1-V4 until the soil moisture level drops below a certain threshold.

One issue of such a water system is the difficulty of controlling electronic valves based on their respective local soil moisture levels. For example, for a large area with trees and buildings, the soil conditions at different locations might be different. However, the soil moisture level received at the sensor port would cause all electronic valves to be shut down. It might be more efficient to control the electronic valves individually based on the local soil near each valve without shutting down all valves based on one soil condition feedback.

### BRIEF SUMMARY OF THE INVENTION

A relay device capable of being connected between a main controller and an electronic valve and signally connected with a soil moisture sensor. The relay device includes a first terminal, a second terminal, a transceiver, and a switch. The first terminal is for being electrically connected with the main controller. The second terminal is for being electrically connected with the electronic valve. The transceiver is for signally connected with the soil moisture sensor. The switch is for controlling an opening and closing of the electrical connection between the first terminal and the second terminal according to a soil moisture level received from the soil moisture sensor.

In one embodiment, the relay device may include a setting unit on an exterior surface of the relay device for allowing a moisture threshold to be set. The moisture threshold may include an upper threshold for opening the electrical connection when the soil moisture level received from the soil moisture sensor is higher than the upper threshold. The moisture threshold may also include a lower threshold for closing the electrical connection when the soil moisture level received from the soil moisture sensor is lower than the lower threshold. The setting unit may be a physical dial.

In one embodiment, the transceiver is signally connected with the soil moisture sensor wirelessly.

A watering system is also disclosed, which includes a main controller, an electronic valve, a soil moisture sensor, and a relay device. The main controller has a plurality of valve-controlling ports, and the electronic valve is for controlling a water flow to a sprinkler. The relay device includes a first terminal, a second terminal, a transceiver, and a switch. The first terminal is for being electrically connected with the main controller. The second terminal is for being electrically connected with the electronic valve. The transceiver is for signally connected with the soil moisture sensor. The switch is for controlling an opening and closing of the electrical connection between the first terminal and the second terminal according to a soil moisture level received from the soil moisture sensor.

### BRIEF DESCRIPTION OF THE DRAWINGS

FIG. 1 (Related Art) is a schematic diagram showing a conventional watering system.

FIG. 2 is a schematic diagram showing a watering system according to an embodiment of the disclosure.

### DETAILED DESCRIPTION OF THE INVENTION

To facilitate understanding of the object, characteristics and effects of this present disclosure, embodiments together with the attached drawings for the detailed description of the present disclosure are provided.

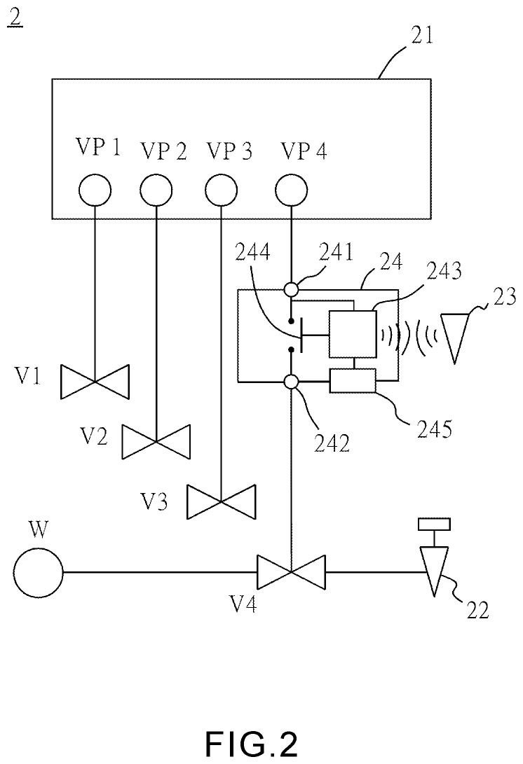

Referring to FIG. 2, the watering system 2 according to an embodiment of this disclosure includes a main controller 21, a plurality of electronic valves V1-V4, a sprinkler 22, a soil moisture sensor 23, and a relay device 24. The main controller 21 has multiple valve-controlling ports VP1-VP4 for controlling the electronic valves V1-V4, respectively. In FIG. 2, for exemplary and concise purpose, the electronic valve V4 controls the water flow from a water source W to the sprinkler 22. In practical applications, the electronic valves V1-V3 may control the water flows form the water source to different sprinklers.

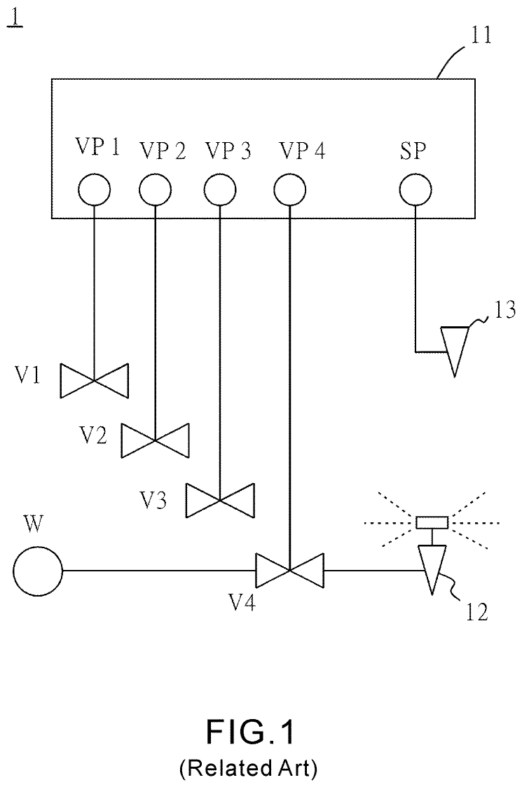

The relay device 24 includes a first terminal 241, a second terminal 242, a transceiver 243, a switch 244 and a setting unit 245. The first terminal 241 is electrically connected to the valve-controlling port VP4 of the main controller 21, and the second terminal 242 is electrically connected with the electronic valve V4. That is, compared to the direct connection between the valve-controlling port VP4 of the main controller 21 and the electronic valve V4 shown in FIG. 1, in FIG. 2 the relay device 24 is added between the valve-controlling port VP4 and the electronic valve V4. In practical applications, a two-wire cable may be used to connect the valve-controlling port VP4 to the first terminal 241, and another two-wire cable may be used to connect the electronic valve V4 to the second terminal 242.

The transceiver 243 is signally connected with the soil moisture sensor 23. The soil sensor 23 may be battery powered and send soil moisture level data via a LoRaWAN (long range wide-area network) or Bluetooth wireless network upon request. The transceiver 243 may be powered by the electrical power from the valve-controlling port VP4 and send a request via the LoRaWAN or Bluetooth wireless network to the soil moisture sensor 23 to receive the soil moisture level from the soil moisture sensor 23. In one example, the transceiver 243 may send the request once or twice per day, or upon receiving the power from the main controller 21.

The switch 244 is controlled based on the soil moisture level. For example, the switch 244 may open of the electrical connection between the first terminal 241 and the second terminal 242 if the soil moisture level is higher than a predetermined moisture threshold. The switch 244 may also close the electrical connection between the first terminal 241 and the second terminal 242 if the soil moisture level is lower than the moisture threshold. In another example, two threshold values such as a higher threshold and a lower threshold may be set. The switch 244 may open of the electrical connection if the soil moisture level is higher than the higher threshold and close the electrical connection if the soil moisture level is lower than the lower threshold.

The setting unit 245 is disposed on the exterior surface of the relay device 24 for setting the moisture threshold, the higher threshold or the lower threshold mentioned above. For example, the setting unit 245 may be a physical dial for a user to set the moisture value manually. The setting unit 245 may also be several buttons or a rotating knob, depending on different practical applications.

Since the relay device 24 is disposed only between the main controller 21 and the electronic valve V4, the operations of the other three valves V1-V3 are still controlled by the main controller 21 based on the watering schedule without being affected by the soil moisture level. Only the operation of the electronic valve V4 is affected by the soil moisture level. Therefore, individual valve control based on soil condition can be realized, which makes the configuration and operation of the watering system 2 be more flexible compared to conventional watering systems. For example, the electronic valves V1-V3 may be disposed at locations with no tree to shield the sunlight, while the electronic valves V4 may be disposed under the trees together with the soil moisture sensor 23. The main controller 21 controls the electronic valves V1-V3 to spray water according to a preset watering schedule, but such water may be too much for the location with trees. With the aid of the relay device 24, the soil moisture level would be additionally considered at the location with trees, and the watering of the sprinkler 22 corresponding to the electronic valve V4 will be stopped if the soil is still too wet due to the sunlight-shielding effect of the trees. This makes the water usage more efficient in view of the actual environment of the watering system.

Furthermore, since the operation of the relay device 24 of the present embodiment is not controlled by the main controller, the relay device 24 may be used with any types of main controller as long as the first terminal 241 is compatible with the valve-controlling ports. Therefore, it is possible for a user to simply deploy the relay device 24 and a soil moisture sensor into his or her existing watering system to additionally control a specific valve based on the soil moisture level without replacing the existing main controller.

Moreover, in the present embodiment, the relay device 24 is powered by the valve-controlling port VP4 of the main controller 21. Therefore, the relay device 24 is powered only when the main controller 21 activates the electronic valve V4 for watering purpose, which means that the transceiver 243 only sends requests to the soil moisture sensor 23 after being powered by the main controller 21. With such design, more precise water-saving operations may be achieved. For example, the main controller 21 may activate the electronic valve V4 for 20 minutes based on an original watering schedule. During this 20-minute period, the relay device 24 may request the most up-to-date soil moisture level data every minute, so that the watering period may be shortened to less than 20 minutes. This makes the water usage of the watering system 2 more efficient.

It should be understood that various modifications may be made to the relay device and the watering system described above. For example, the soil moisture sensor may be signally connected with the transceiver of the relay device by wire and send signals via the RS-485 communication protocol. The relay device may have its own power source, such as a rechargeable battery chargeable by the power from the main controller or a solar panel, to support the operation of the transceiver.

It is possible that two relay devices are deployed between the main controller and to electronic valves, respectively, so that two electronic valves are controlled with the consideration of the soil moisture level sent form the soil moisture sensor. It is also possible that the soil moisture sensor and the relay device may be “paired” with a specific ID. Such design allows multiple “sensor-relay pairs” to be deployed within a watering system without interfering with each other, which makes the watering system even more flexible.

Therefore, while the present disclosure has been described by means of specific embodiments, numerous modifications and variations could be made thereto by those skilled in the art without departing from the scope and spirit of the present disclosure set forth in the claims.

What is claimed is:

1. A relay device capable of being connected between a main controller and an electronic valve and signally connected with a soil moisture sensor, the main controller having a plurality of valve-controlling ports, the relay device comprising:
a first terminal for being electrically connected with one of the valve-controlling ports of the main controller;
a second terminal for being electrically connected with the electronic valve;
a transceiver for signally connected with the soil moisture sensor; and
a switch for controlling an opening and closing of the electrical connection between the first terminal and the second terminal according to a soil moisture level received from the soil moisture sensor.

2. The relay device according to claim 1, further comprising:
a setting unit on an exterior surface of the relay device for allowing a moisture threshold to be set.

3. The relay device according to claim 2, wherein the moisture threshold comprises an upper threshold for opening the electrical connection when the soil moisture level received from the soil moisture sensor is higher than the upper threshold.

4. The relay device according to claim 2, wherein the moisture threshold comprises a lower threshold for closing the electrical connection when the soil moisture level received from the soil moisture sensor is lower than the lower threshold.

5. The relay device according to claim 2, wherein the setting unit is a physical dial.

6. The relay device according to claim 1, wherein the transceiver is signally connected with the soil moisture sensor wirelessly.

7. A watering system, comprising:
a main controller having a plurality of valve-controlling ports;
an electronic valve for controlling a water flow to a sprinkler;
a soil moisture sensor; and
a relay device comprising:
a first terminal for being electrically connected with one of the plurality of valve-controlling ports of the main controller;
a second terminal for being electrically connected with the electronic valve;
a transceiver for signally connected with the soil moisture sensor; and
a switch for controlling an opening and closing of the electrical connection between the first terminal and the second terminal according to a soil moisture level received from the soil moisture sensor.

8. The watering system according to claim 7, further comprising:
a setting unit on an exterior surface of the relay device for allowing a moisture threshold to be set.

9. The watering system according to claim 7, wherein the moisture threshold comprises an upper threshold for opening the electrical connection when the soil moisture level received from the soil moisture sensor is higher than the upper threshold.

10. The watering system according to claim 8, wherein the moisture threshold comprises a lower threshold for closing the electrical connection when the soil moisture level received from the soil moisture sensor is lower than the lower threshold.

11. The watering system according to claim 8, wherein the setting unit is a physical dial.

12. The watering system according to claim 7, wherein the transceiver is signally connected with the soil moisture sensor wirelessly.
